(19) United States
(12) Patent Application Publication
(10) Pub. No.: US 2013/0074005 A1
(43) Pub. Date: Mar. 21, 2013

(54) SYSTEM, METHOD AND GRAPHICAL USER INTERFACE FOR DISPLAYING AND CONTROLLING VISION SYSTEM OPERATING PARAMETERS

(71) Applicants: Steven Whitman, Danville, NH (US); Robert J. Tremblay, Grafton, MA (US); Carroll Arbogast, JR., Needham, MA (US); G. Scott Schuff, Ashland, MA (US); Emily Hart, Somerville, MA (US)

(72) Inventors: Steven Whitman, Danville, NH (US); Robert J. Tremblay, Grafton, MA (US); Carroll Arbogast, JR., Needham, MA (US); G. Scott Schuff, Ashland, MA (US); Emily Hart, Somerville, MA (US)

(73) Assignee: COGNEX CORPORATION, Natick, MA (US)

(21) Appl. No.: 13/565,609

(22) Filed: Aug. 2, 2012

Related U.S. Application Data
(63) Continuation-in-part of application No. 12/758,455, filed on Apr. 12, 2010.
Application No. 12/758,455 is a continuation of application No. 10/988,120, filed on Nov. 12, 2004, now Pat. No. 7,720,315.
Application No. 10/988,120 is a continuation-in-part of application No. 12/566,957, filed on Sep. 25, 2009.

(51) Int. Cl. G06F 3/0481

(52) U.S. Cl. CPC G06F 3/0481
USPC 715/799

(57) ABSTRACT

A system, method and GUI for displaying and controlling vision system operating parameters includes an automated region of interest (ROI) graphic image that is applied to a discrete region of a selected image in response to a single click by a user. At least one automated operating parameter is generated automatically in response to the single click by the user at the discrete region, so as to determine whether a feature of interest (such as a pattern, a blob or an edge) is in the automated ROI graphic image. Illustratively, the automated ROI graphic image (a pass/fail graphic image) is user-movable to allow the user to move the automated ROI graphic image from a first positioning to a second positioning, to thereby automatically reset the operating parameter to a predetermined value in accordance with the second positioning.

### RELATED APPLICATIONS

This application is a continuation-in-part of U.S. patent application Ser. No. 12/758,455, filed Apr. 12, 2010, entitled SYSTEM AND METHOD FOR DISPLAYING AND USING NON-NUMERIC GRAPHIC ELEMENTS TO CONTROL AND MONITOR A VISION SYSTEM, the entire disclosure of which is herein incorporated by reference, which is a continuation of U.S. patent application Ser. No. 10/988,120, filed Nov. 12, 2004, entitled SYSTEM AND METHOD FOR DISPLAYING AND USING NON-NUMERIC GRAPHIC ELEMENTS TO CONTROL AND MONITOR A VISION SYSTEM, the entire disclosure of which is herein incorporated by reference. This application is also a continuation-in-part of U.S. patent application Ser. No. 12/566,957, filed Sep. 25, 2009, entitled SYSTEM AND METHOD FOR VIRTUAL CALIPER, the entire disclosure of which is herein incorporated by reference.

### FIELD OF THE INVENTION

The present invention relates to systems, methods and graphical user interfaces for determining whether an object or any portion thereof is at the correct position.

### BACKGROUND OF THE INVENTION

Industrial manufacturing relies on automatic inspection of objects being manufactured. One form of automatic inspection that has been in common use for decades is based on optoelectronic technologies that use electromagnetic energy, usually infrared or visible light, photoelectric sensors (such as photodetectors), and some form of electronic decision making.

Machine vision systems avoid several disadvantages associated with conventional photodetectors. They can analyze patterns of brightness reflected from extended areas, easily handle many distinct features on the object, accommodate line changeovers through software systems and/or processes, and handle uncertain and variable object locations.

By way of example, FIG. 1 shows an illustrative embodiment of a vision detector 100 according to an illustrative embodiment for inspecting objects on a production line. A conveyor 102 transports objects to cause relative movement between the objects and the field of view (FOV) of vision detector 100. Objects 110, 112, 114, 116 and 118 are shown. In this example, the objects include exemplary features upon which location and inspection are based, including a label 120 and a hole 124. More particularly, the exemplary vision detector 100 detects the presence of an object by visual appearance and inspects it based on appropriate inspection criteria. If an object is defective (such as the label-less object 116), the vision detector 100 sends a signal via link 150 to a reject actuator 170 to remove the object (116) from the conveyor stream. An encoder 180 operatively related to the motion of the conveyor (or other relative motion) sends a signal 160 to the vision detector 100, which uses it to insure proper delay of signal 150 from the encoder count where the object crosses some fixed, imaginary reference point 190, called the mark point. If an encoder is not used, the delay can be based on time instead.

In an alternate example, the vision detector 100 sends signals to a PLC for various purposes, which may include controlling a reject actuator. In another exemplary implementation, suitable in extremely high-speed applications or where the vision detector cannot reliably detect the presence of an object, a photodetector is used to detect the presence of an object and sends a signal to the vision detector for that purpose. In yet another implementation, there are no discrete objects, but rather material flows past the vision detector continuously—for example a web. In this case the material is inspected continuously, and signals are sent by the vision detector to automation equipment, such as a PLC, as appropriate.

Basic to the function of the vision detector 100 is the ability to exploit the abilities of the imager's quick-frame-rate and low-resolution image capture to allow a large number of image frames of an object passing down the line to be captured and analyzed in real-time. Using these frames, the apparatus' on-board processor can decide when the object is present and use location information to analyze designated areas of interest on the object that must be present in a desired pattern for the object to “pass” inspection.

As the above-described systems become more advanced and available, users may be less familiar with all the settings and functions available to them. Thus, it is desirable to provide a system that allows features on an object to be detected and analyzed in a more automatic (or automated) manner that is intuitive to a user and not excessively time consuming. Such a system is desirably user-friendly and automatically identifies features of interest in an image.

### SUMMARY OF THE INVENTION

The disadvantages of the prior art can be overcome by providing a graphical user interface (GUI)-based system for generating and displaying vision system operating parameters. The system employs automated position tools to determine whether a feature of interest is in the proper location, such as a pattern, blob or edge. The operating parameters are automatically generated for the automated position tool, without requiring (free of) manual input from a user.

In an illustrative embodiment, an automated region of interest graphic image is applied to a discrete region of a selected image in response to a single click by a user at the discrete region of the selected image. The image is selected by the user from a window on the GUI display containing a plurality of captured images of an object. An automated operating parameter is generated automatically in response to the single click by the user at the discrete region of the selected image to determine whether a feature of interest is in the automated region of interest graphic image. Illustratively, the automated region of interest graphic image is user-movable to allow the user to move the automated region of interest graphic image from a first positioning on the selected image to a second positioning on the selected image, to thereby automatically reset the at least one automated operating parameter to a predetermined value in accordance with the second positioning of the automated region of interest graphic image.

In an illustrative embodiment, the automated region of interest graphic image is applied by a pattern position tool and the feature of interest comprises a pattern. The at least one automated operating parameter for the pattern position tool can comprise an X position, a Y position, an angle position and other operating parameters that are automatically set, such as determining the score threshold for a found object. The automated region of interest graphic image can also be applied by a blob position tool and the feature of interest can comprise a blob. At least one of the operating parameters comprises an X position or a Y position. The automated region of interest graphic image can also be applied by an edge position tool where the feature of interest comprises an edge. According to an edge position tool, the automated operating parameters comprise at least one of X position, Y position and angle position.

A method for displaying and controlling vision system operating parameters comprises applying an automated region of interest graphic image to a discrete region of a selected image on a GUI in response to a single click by a user. The method continues by generating at least one automated operating parameter automatically in response to the single click by the user, so as to determine whether a feature of interest (pattern, blob or edge) is in the automated region of interest graphic image. Illustratively, the automated region of interest graphic image is user-movable to allow the user to move the automated region of interest graphic image from a first positioning on the selected image to a second positioning on the selected image, to thereby automatically reset the at least one automated operating parameter to a predetermined value in accordance with the second positioning of the automated region of interest graphic image.

### BRIEF DESCRIPTION OF THE DRAWINGS

The invention description below refers to the accompanying drawings, of which:

FIG. 1, already described, is a schematic diagram of an exemplary implementation of a vision detector, inspecting objects on a production line, according to a prior art illustrative embodiment;

FIG. 2 is a block diagram of an illustrative embodiment of a vision detector according to an illustrative embodiment;

FIG. 3 is a diagram of a graphical user interface (GUI) display for displaying and controlling vision detector operating parameters, according to an illustrative embodiment;

FIG. 4 is a partial view of the diagram of the GUI display of FIG. 3, detailing an image view and associated control box with a cursor having automatically placed an edge-detecting Locator of predetermined size and angle on the image view, and an exemplary threshold bar and setting slider within the control box, according to the illustrative embodiment;

FIG. 5 is a diagram of a GUI display for applying a caliper tool to a vision detector, according to an illustrative embodiment;

FIG. 6 is a diagram of various position displacements that a vision tool can detect and measure in accordance with the illustrative embodiments;

FIG. 7 is a flow chart of a procedure for overall system operation employing position tools, according to the illustrative embodiments;

FIG. 8 is a diagram of an exemplary GUI display showing a pattern position tool and the associated automated operating parameters, according to an illustrative embodiment;

FIG. 9 is a flow chart of a procedure for generating and applying a pattern position tool, according to the illustrative embodiment;

FIG. 10 is a diagram of an exemplary GUI display showing an exemplary bottle application of the pattern position tool, according to an illustrative embodiment;

FIG. 11 is a flow chart of a procedure for generating an object position tool, according to an illustrative embodiment;

FIG. 12 is a diagram of an exemplary GUI display for an object position tool application, according to the illustrative embodiment;

FIG. 13 is a diagram of an exemplary GUI display for the object position tool application, detailing an operating parameter for the width of the object, according to the illustrative embodiment;

FIG. 14 is a diagram of an exemplary GUI display for the object position tool application, detailing an operating parameter for object match, according to the illustrative embodiment;

FIG. 15 is a diagram of an exemplary GUI display for the object position tool application, detailing an operating parameter for object polarity, according to the illustrative embodiment;

FIG. 16 is a diagram of an exemplary GUI display for the object position tool application, detailing an operating parameter for object level, according to the illustrative embodiment;

FIG. 17 is a perspective view of an exemplary application of a region of interest of the object position tool, according to an illustrative embodiment;

FIG. 18 is a flow chart of a procedure for generating an edge position tool, according to an illustrative embodiment; and

FIG. 19 is a diagram of a GUI display for the edge position tool and associated automated operating parameters applied thereto, according to the illustrative embodiment.

### DETAILED DESCRIPTION

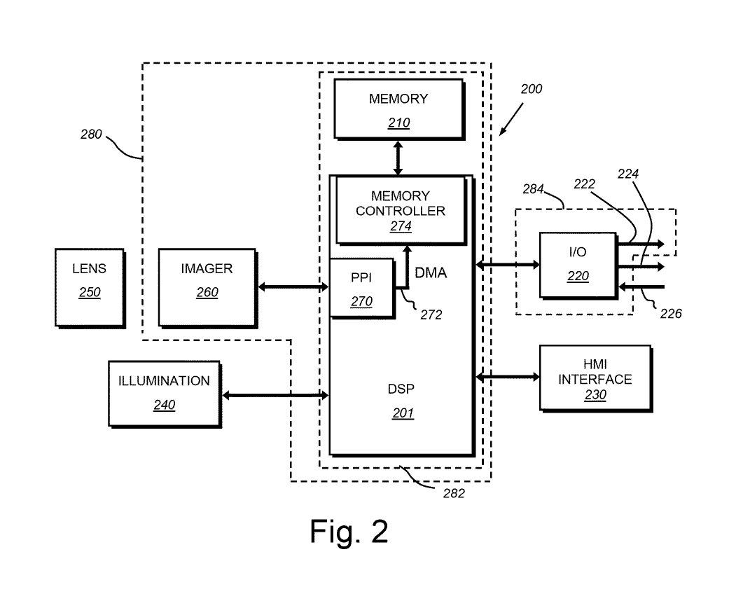

Reference is made to FIG. 2 showing a block diagram of a vision detector 200 according to an illustrative embodiment. A digital signal processor (DSP) 201 runs software to control capture, analysis, reporting, HMI communications, and any other appropriate functions needed by the vision detector. The DSP 201 is interfaced to a memory 210, which includes high-speed random access memory for programs and data and non-volatile memory to hold programs and setup information when power is removed. The DSP 201 is also connected to an I/O module 220 that provides signals to automation equipment, an HMI interface 230, an illumination module 240, and an imager 220. A lens 250 focuses images onto the photosensitive elements of the imager 260.

The DSP 201 can be any device capable of digital computation, information storage, and interface to other digital elements, including but not limited to a general-purpose computer, a PLC, or a microprocessor. It is desirable that the DSP 201 be inexpensive but fast enough to handle a high frame rate. It is further desirable that it be capable of receiving and storing pixel data from the imager simultaneously with image analysis.

In the illustrative embodiment of FIG. 2, the DSP 201 is an ADSP-BF531 manufactured by Analog Devices of Norwood, Mass. An ADSP-BF53x would operate at a reduced level of performance compared to the ADSP-BF561 manufactured by Analog Devices of Norwood, Mass. In the illustrated arrangement, the Parallel Peripheral Interface (PPI) 270 of the ADSP-BF531 DSP 201 receives pixel data from the imager 260, and sends the data to memory controller 274 via Direct Memory Access (DMA) channel 272 for storage in memory 210. The use of the PPI 270 and DMA 972 allows, under appropriate software control, image capture to occur simultaneously with any other analysis performed by the DSP 201. Software instructions to control the PPI 270 and DMA 272 can be implemented by one of ordinary skill in the art following the programming instructions contained in the ADSP-BF533 Blackfin Processor Hardware Reference (part number 82-002005-01), and the Blackfin Processor Instruction Set Reference (part number 82-000410-14), both incorporated herein by reference. Note that the ADSP-BF531, and the compatible ADSP-BF532 and ADSP-BF533 devices, as well as the ADSP-BF561, have identical programming instructions and can be used interchangeably in this illustrative embodiment to obtain an appropriate price/performance tradeoff. The ADSP-BF532, ADSP-BF533 and ADSP-BF561 devices are substantially similar and have very similar peripheral support, for example, for the PPI and DMA.

The high frame rate desired by a vision detector suggests the use of an imager unlike those that have been used in prior art vision systems. It is desirable that the imager be unusually light-sensitive, so that it can operate with extremely short shutter times using inexpensive illumination. It is further desirable that it be able to digitize and transmit pixel data to the DSP far faster than prior art vision systems. It is moreover desirable that it be inexpensive and has a global shutter.

These objectives may be met by choosing an imager with much higher light sensitivity and lower resolution than those used by prior art vision systems. In the illustrative embodiment of FIG. 2, the imager 260 is an LM9630 manufactured by National Semiconductor of Santa Clara, Calif. The LM9630 has an array of 128.times.100 pixels, for a total of 12800 pixels, about 24 times fewer than typical prior art vision systems. The pixels are relatively large at approximately 20 microns square, providing high light sensitivity. The LM9630 can provide 500 frames per second when set for a 300-microsecond shutter time, and is sensitive enough (in most cases) to allow a 300-microsecond shutter using LED illumination. This resolution would be considered far too low for a vision system, but is quite sufficient for the feature detection tasks that are the objectives of the present invention. Electrical interface and software control of the LM9630 can be implemented by one of ordinary skill in the art following the instructions contained in the LM9630 Data Sheet, Rev 1.0, January 2004, which is incorporated herein by reference. In an illustrative embodiment, the imager 260 can also be an Aptina MTV024 imager which has an array of 752.times.480 pixels, for a total of 360960 pixels. This Aptina MTV024 imager has a reduced frame rate.

It is desirable that the illumination 240 be inexpensive and yet bright enough to allow short shutter times. In an illustrative embodiment, a bank of high-intensity red LEDs operating at 230 nanometers is used, for example the HLMP-ED25 manufactured by Agilent Technologies. In another embodiment, high-intensity white LEDs are used to implement desired illumination. In other embodiments, green and blue LEDs can be employed, as well as color filters that reject light wavelengths other than the wavelength(s) of interest.

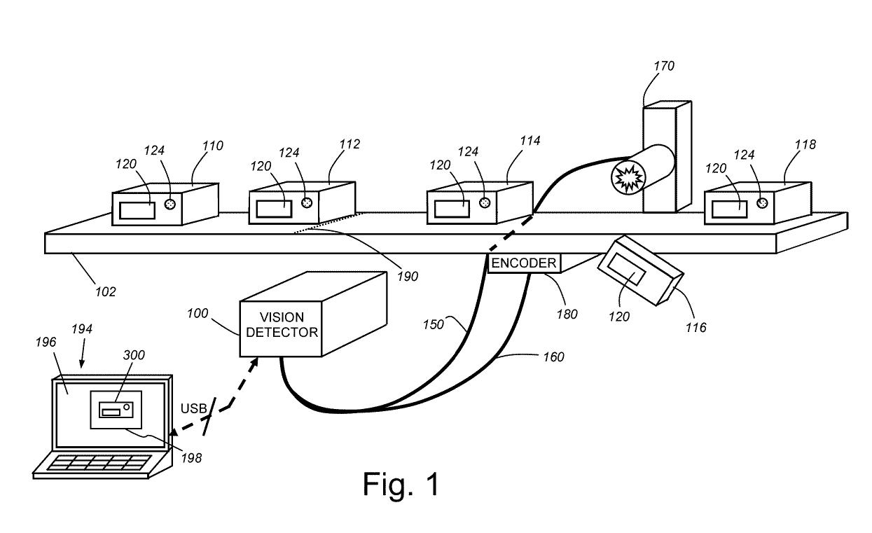

In the illustrative embodiment of FIG. 2, the I/O module 220 provides output signals 222 and 224, and input signal 226. One such output signal can be used to provide a signal (150 in FIG. 1) for control of the reject actuator 170. Input signal 226 can be used to provide an external trigger.

As used herein an “image capture device” provides means to capture and store a digital image. In the illustrative embodiment of FIG. 2, the image capture device 280 collectively comprises a DSP 201, imager 260, memory 210, and associated electrical interfaces and software instructions. As used herein, an “analyzer” provides means for analysis of digital data, including but not limited to a digital image. In the illustrative embodiment, the analyzer 282 comprises a DSP 201, a memory 210, and associated electrical interfaces and software instructions. Also as used herein, an “output signaler” provides means to produce an output signal responsive to an analysis. In the illustrative embodiment, the output signaler 284 comprises an I/O module 220 and an output signal 222.

It will be understood by one of ordinary skill that there are many alternate arrangements, devices, and software instructions that could be used within the scope of the present invention to implement an image capture device 280, analyzer 282, and output signaler 284.

A variety of engineering tradeoffs can be made to provide efficient operation of an apparatus according to the present invention for a specific application. Consider the following definitions:

b fraction of the field of view (FOV) occupied by the portion of the object that contains the visible features to be inspected, determined by choosing the optical magnification of the lens 250 so as to achieve good use of the available resolution of imager 260;

e fraction of the FOV to be used as a margin of error;

n desired minimum number of frames in which each object will typically be seen;

s spacing between objects as a multiple of the FOV, generally determined by manufacturing conditions;

p object presentation rate, generally determined by manufacturing conditions;

m maximum fraction of the FOV that the object will move between successive frames, chosen based on above values; and

r minimum frame rate, chosen based on above values.

From these definitions it can be seen that

$$m \leq \frac{1 - b - e}{n}$$

$$and$$

$$r \geq \frac{sp}{m}$$

To achieve good use of the available resolution of the imager, it is desirable that b is at least 50%. For dynamic image analysis, n is desirably at least 2. Therefore, it is further desirable that the object moves no more than about one-quarter of the field of view between successive frames.

In an illustrative embodiment, reasonable values might be b=75%, e=5%, and n=4. This implies that m.ltoreq.5%, i.e. that one would choose a frame rate so that an object would move no more than about 5% of the FOV between frames. If manufacturing conditions were such that s=2, then the frame rate r would need to be at least approximately 40 times the object presentation rate p. To handle an object presentation rate of 5 Hz, which is fairly typical of industrial manufacturing, the desired frame rate would be at least around 200 Hz. This rate could be achieved using an LM9630 with at most a 3.3-millisecond shutter time, as long as the image analysis is arranged so as to fit within the 5-millisecond frame period. Using available technology, it would be feasible to achieve this rate using an imager containing up to about 40,000 pixels.

With the same illustrative embodiment and a higher object presentation rate of 12.5 Hz, the desired frame rate would be at least approximately 500 Hz. An LM9630 could handle this rate by using at most a 300-microsecond shutter. In another illustrative embodiment, one might choose b=75%, e=15%, and n=5, so that m.ltoreq.2%. With s=2 and p=5 Hz, the desired frame rate would again be at least approximately 500 Hz.

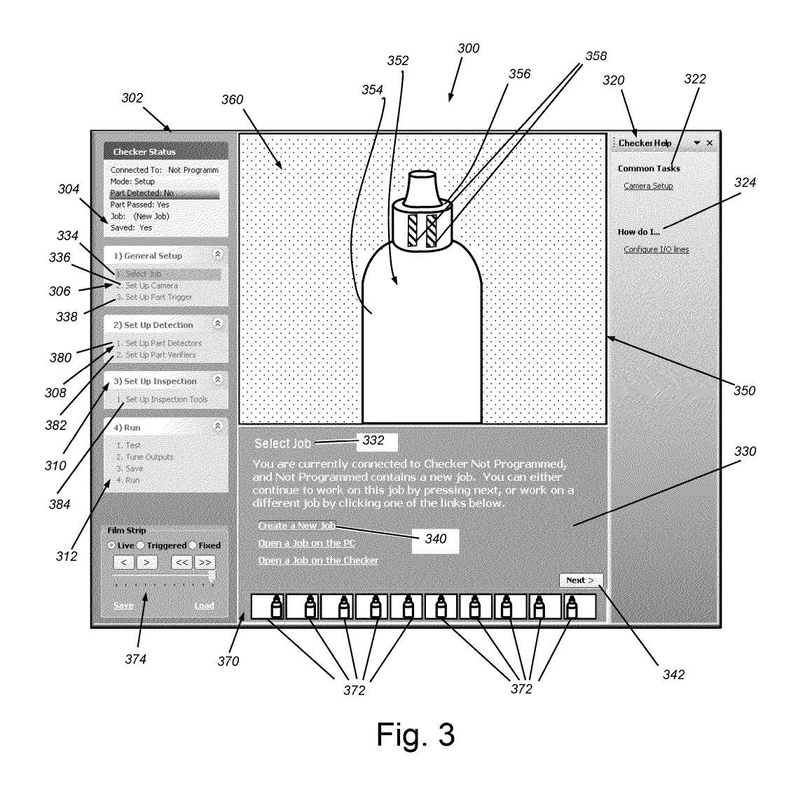

Having described the general architecture and operation of an exemplary vision system (vision Detector 200) that may support an HMI in accordance with an embodiment of this invention vision, reference is now made to FIG. 3, which shows a diagram of a Graphical User Interface (GUI) screen 300 for a Human-Machine Interface (HMI), interconnected with a vision detector (100) like that shown and described with reference to FIG. 1 above. The screen can reside on any acceptable HMI, including, but not limited to an Laptop Personal Computer (PC); Desktop PC, personal digital assistant or Notebook Computer (for example PC 194), cell phone, smart phone, or other appropriate device having an appropriate communication link (e.g. USB, wireless, network cable, etc.) with the vision detector (100). An appropriate HMI interface (described in connection with the above-incorporated-by-reference METHOD AND APPARATUS) interconnects with the exemplary vision detector's DSP to allow communication with the HMI. Note that the layout and menu contents of the illustrated screen 300 is exemplary, and a variety of layouts and menu items are contemplated in alternate embodiments. As described above, it is contemplated that the HMI is interconnected to the detector during setup and monitoring or testing. During normal runtime on a production line, the HMI may be disconnected and the detector freely operates various alarms, reject actuators (170) and other interconnected devices, while receiving optical inputs from illuminated objects and electronic inputs from line devices such as the encoder (180).

In this embodiment, the GUI 300 is provided as part of a programming application running on the HMI and receiving interface information from the vision detector. In the illustrative embodiment, a .NET framework, available From Microsoft Corporation of Redmond, Wash., is employed on the HMI to generate GUI screens. Appropriate formatted data is transferred over the link between the vision detector and HMI to create screen displays and populate screen data boxes, and transmit back selections made by the user on the GUI. Techniques for creating appropriate screens and transferring data between the HMI and vision detector's HMI interface should be clear to those of ordinary skill and are described in further detail below.

The screen 300 includes a status pane 302 in a column along the left side. This pane controls a current status box 304, the dialogs for controlling general setup 306, setup of object detection with Locators and Detectors 308, object inspection tool setup 310 and runtime/test controls 312. The screen 300 also includes a right-side column having a pane 320 with help buttons.

The lower center of the screen 300 contains a current selection control box 330. The title 332 of the box 330 relates to the selections in the status pane 302. In this example, the user has clicked select job 334 in the general setup box 306. Note, the general setup box also allows access to an item (336) for accessing a control box (not shown) that enables setup of the imager (also termed “camera”), which includes, entry of production line speed to determine shutter time and gain. In addition, the general setup box allows the user to set up a part trigger (item 338) via another control box (not shown). This may be an external trigger upon which the imager begins active capture and analysis of a moving object, or it may be an “internal” trigger in which the presence of a part is recognized due to analysis of a certain number of captured image frames (as a plurality of complete object image frames are captured within the imager's field of view).

The illustrated select job control box 330 allows the user to select from a menu 340 of job choices. In general, a job is either stored on an appropriate memory (PC or vision detector or is created as a new job. Once the user has selected either a stored job or a new job, the next button accesses a further screen with a Next button 342. These further control boxes can, by default, be the camera setup and trigger setup boxes described above.

Central to the screen 300 is the image view display 350, which is provided above the control box 330 and between the columns 302 and 320 (being similar to image view window 198 in FIG. 1). This display shows a current or stored image frame captured by the vision detector and, essentially, represents the vision detector's current field of view (FOV). In this example, an object 352 is approximately centered in the display. For the purposes of describing the illustrative embodiment, the exemplary object 352 is a bottle on a moving line having a main cylindrical body 354 having a narrowed upper cap section 356 with a series of graphics 358 thereon. Any acceptable object or pattern can be substituted herein and the relative motion between the object and the field of view can be generated by moving the objects, moving the vision detector (or moving its FOV) or moving both the objects and the vision detector. In this example, the object 352 is relative light in surface color/shade. While the background 360 is relatively dark (as depicted by dot shading), in general, there should exist sufficient contrast or shade differences between at least some portions of the object and the background to attain a basis for detecting and inspecting the object. However, it is contemplated that the object may be mostly dark and the background can be lighter in an alternate example.

As shown in FIG. 3, the object 352 is either a real-time image being returned from the vision detector under appropriate illumination or it is a stored image. In either case, the image in display 350 is the one upon which setup of the detector is performed. In this example, the object 352 is centered in the display 350 with background space on either side. In other examples, the object may be moved more closely to a side of the display, such as when detection and inspection are based upon internal features located at a distance from an edge.

Before describing further the procedure for manipulating and using the GUI and various non-numeric elements according to this invention, reference is made briefly to the bottommost window 370 which includes a line of miniaturized image frames that comprise a so-called “film strip” of the current grouping of stored, captured image frames 372. These frames 372 each vary slightly in bottle position with respect to the FOV, as a result of the relative motion. The film strip is controlled by a control box 374 at the bottom of the left column.

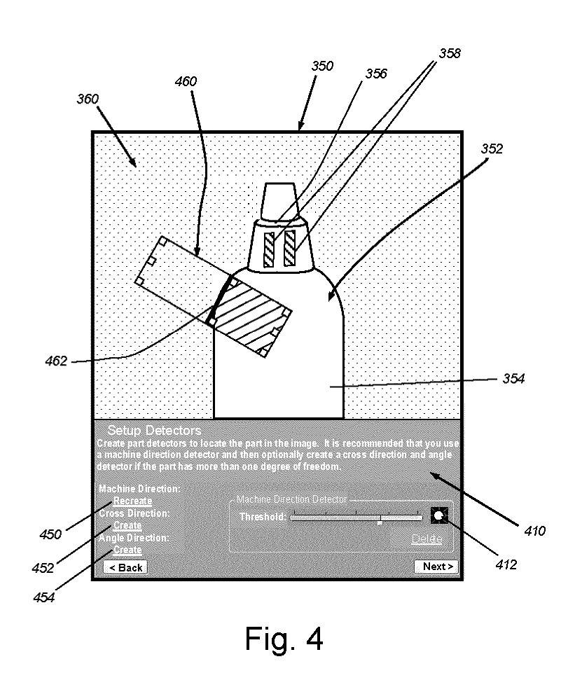

Reference is now made to FIG. 4 showing a partial view of the diagram of the GUI display of FIG. 3, detailing an image view and associated control box with a cursor having automatically placed an edge-detecting locator of predetermined size and angle on the image view, and an exemplary threshold bar and setting slider within the control box, according to the illustrative embodiment. After performing other general setup functions (see box 306 in FIG. 3), the user may set up the mechanism for detecting the object 352 using the vision detector that is used herein as an example of a “vision system.” The user clicks the setup detectors button 380 in FIG. 3 to access the control box 410. Within this box the user may decide which direction he or she wishes to have detection occur. The choices are machine or line-movement direction (typically horizontally or left-to right/right-to-left across the FOV) (button 450), cross direction (typically vertically or transverse to machine direction) (button 452) or angle direction (button 454). Once a direction is chosen for a main detector (note that additional directions may be chosen by accessing the control box 410 at a later time), the box 410 invites the user to click on a location in the object image, and that click generates a rectangular Locator ROI graphic 460 with an associated plunger 462 that fits to an adjacent edge of the object 352, as shown. A detailed description of an automated system and method for placing and sizing both Locators and Detectors is taught in commonly assigned U.S. Pat. No. 7,636,449, entitled SYSTEM AND METHOD FOR ASSIGNING ANALYSIS PARAMETERS TO A VISION DETECTOR USING A GRAPHICAL INTERFACE, the teachings of which are expressly incorporated herein by reference. The generalized threshold level is also set by the automated process based upon the overall difference between the light and dark pixels along the edge transition adjacent to the Locator 460. In brief summary, the threshold level determines how much transition along an edge or other feature is needed to turn the Locator “on.”

In this example, when the user “clicks” on the cursor placement, the screen presents the control box 410, which now displays an operating parameter box 412. This operating parameter box 412 displays a single non-numeric parameter bar element 414 that reports threshold for the given Locator.

### Virtual Caliper Tool

Once an object has been located within a field of view using the detectors of FIG. 4, it is typically desirable to apply certain tools to the object to determine certain qualitative features (i.e. label misplaced, etc.) without having to set up too many individual parameters and tests. For example, the width of a particular object is desired to be set during the training phase to train the system for the appropriate object width during run-time analysis.

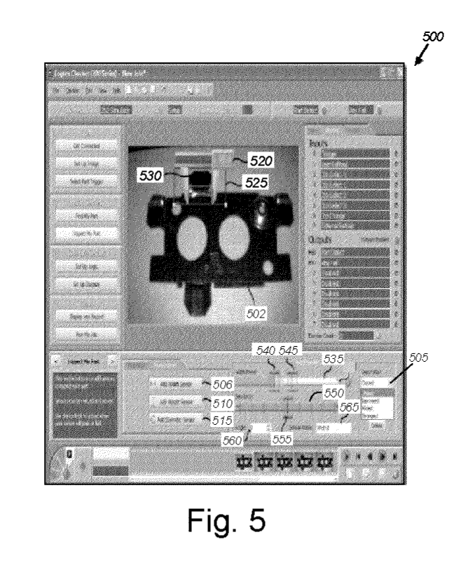

Reference is now made to FIG. 5, showing a diagram of an exemplary graphical user interface (GUI) screen display 500 illustrating options for the selection of edges in accordance with an illustrative embodiment for applying a virtual caliper tool. As shown in the GUI screen 500, a drop-down menu 505 has been expanded to show various alternative techniques for edge detection. In accordance with an illustrative embodiment of the present invention, a user can select any type of edge detection determination that is desired. For example, a user can select using drop-down menu 505, that the closest, narrowest, widest or strongest edges are utilized in making automatic measurements. Illustratively, the closest option utilizes those edges that are closest to the trained edges for detection. The narrowest and the widest options utilize either the narrowest or widest distances from the selected centerpoint. The strongest option utilizes the strongest edges. That is, most edge detection techniques have a weighting value associated with the detection of a particular edge. By selecting the strongest option, those edges having the highest weight values will be selected.

In an illustrative embodiment of the present invention, a user may select one of the blades of the virtual caliper and manually place the blade on an edge that was not automatically selected. Illustratively, the virtual caliper module will recomputed the threshold values based on the manually selected edge. Furthermore, the blade of the virtual caliper may be automatically aligned (snapped) to an edge, thereby ensuring proper alignment.

Although the virtual caliper tool shown in FIG. 5 provides an advantageous feature for image analysis, the user is required to expend effort and judgment during training Some users desire a more automatic/automated option. More particularly, during training, as shown in FIG. 5, there are buttons to add a width sensor 506, a height sensor 510, and a diameter sensor 515, each requiring manipulation of the various operating parameters to set up the virtual caliper. The GUI screen 500 includes a region displaying a component 502 along with a virtual caliper 520. Associated with the virtual caliper 520 is a search region 525. As shown, the virtual caliper 520 is measuring a given set of edges 430. The GUI screen display 500 also includes a threshold bar 535 including high and low threshold sliders 540, 545. Each of these sliders requires manipulation by a user to set up a particular sensor. Additionally, a sensitivity range 550 and a sensitivity slider 555 are identified, each requiring manipulation by the user to manually set-up a caliper tool. The sensitivity slider permits a user to adjust how strong the feature must be in order to be found. Illustratively, selecting the slider will display all of the candidate edges and/or circles that can be found at the current setting or the updated setting if the slider is moved. An angle field 560 enables a user to angle the caliper about an axis, and requires manual user input for this particular operating parameter to set the caliper tool. A sensor name field 565 permits a user to give a particular width/height sensor a name. The virtual caliper, although extremely useful, requires extensive user input and manual adjustment of individual operating parameters during training of an image.

### Automated Position Tools

An automated position tool can be applied which advantageously verifies the position of an object and yields a pass/fail result, without (free-of) requiring extensive parameter entry or user input. According to an illustrative embodiment of the present invention, an automated region of interest graphic image is applied automatically to a discrete region of a selected image in response to a single “click” by a user. By “click” it is generally meant a single activation operation by a user, such as the pressing of a mouse button or touch of another interface device, such as a touch screen. Alternatively, a click can define a set sequence of motions or operations. The discrete region refers to the location on the selected image that a user “clicks” on (or otherwise selects), to apply a graphic region of interest (ROI) graphic image thereto for detection and analysis of features of interest within the ROI graphic image. Also, a single “click” of the user refers to the selection of the discrete region by a user “clicking” or otherwise indicating a particular location to apply the ROI graphic image. The ROI graphic image is applied automatically in response to this single click and, advantageously, automatically generates the operating parameters associated with the ROI graphic image, without (free of) requiring manual input from a user.

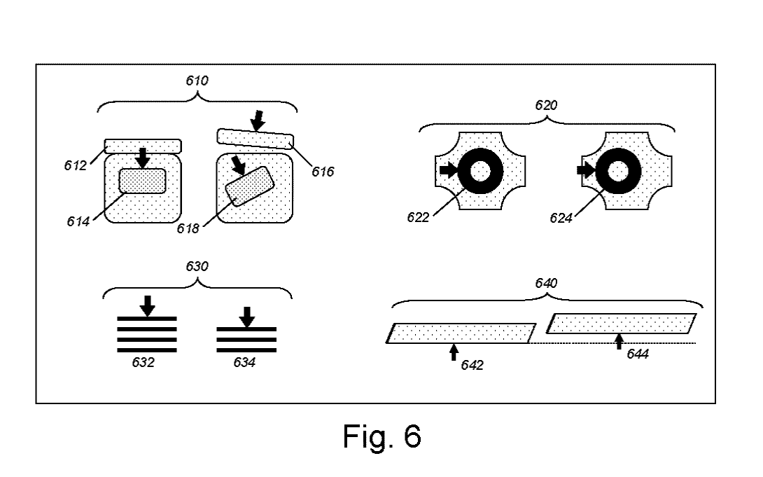

Reference is now made to FIG. 6, showing various position tools that can be applied to verify the position of objects and generate operating parameters automatically, according to an illustrative embodiment. The system desirably provides a pass/fail result based upon whether the operating parameters indicate that a feature of interest is located within a region of interest graphic image. In various vision procedures, it is desirable, once an object has been located, to determine certain qualitative features of the object, to indicate whether a defect is present by verifying the position of a feature of interest. The feature of interest can comprise any feature known in the art, as shown and described herein relating to features of a pattern, an edge or a blob (object or sub-object), readily applicable to those having ordinary skill within the art employing the teachings herein.

It is desirable to provide a graphical pass/fail region to a user to determine the correct position of items, for example in the illustrative positioning arrangements shown in FIG. 6, in which the operating parameters are automatically generated for the user. For example, a label or cap position tool application 610, can be employed to determine if an exemplary label or cap is at the correct position by applying a pass/fail region in accordance with the illustrative embodiments described herein. Illustratively, the exemplary cap 612 and label 614 are in the pass region and yield a pass result. However, the cap 616 and label 618 are not in the pass region and thus fail, according to the illustrative embodiment.

Likewise, a component placement position tool application 620 can be employed to determine appropriate placement of a particular component. As shown in FIG. 6, component 622 is at the correct position and yields a pass result, while component 624 is not at the correct position and yields a fail result. According to the illustrative embodiments described in greater detail hereinbelow, a user can graphically select the pass/fail region for a particular component (or other feature) to determine whether the component will pass or fail for purposes of runtime inspection. A fill level position tool application 630 can also be employed, as shown in FIG. 6, to determine whether an object is at the appropriate fill level. An object having a fill level of 632 yields a pass result, while a fill level of 634 yields a fail result. A web or cable position tool application 640 can also be employed in accordance with the illustrative embodiments herein. Illustratively, an exemplary web or cable position 642 yields a pass result, while a web or cable position 644 yields a fail result. The teachings herein are readily application to these and other applications for inspection of objects to determine whether a particular feature of interest is at a desired location. It is desirable to automatically determine the position of various tool applications 610, 620, 630, 640, and associated features of interest, and other applications known in the art, that require minimal user interaction in training an image for analysis and processing runtime.

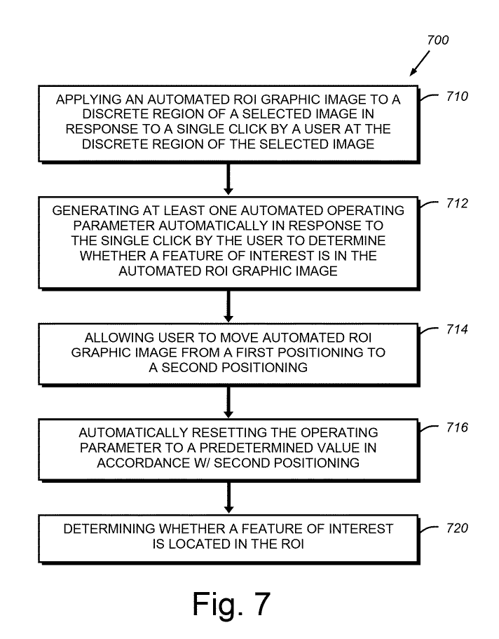

Reference is now made to FIG. 7 showing a flow chart of a procedure 700 for overall system operation, according to an illustrative embodiment for generating and displaying automated operating parameters. As shown, the procedure commences at step 710 by applying an automated region of interest (ROI) graphic image to a discrete region of a selected image in response to a single click by a user at the discrete region of the selected image. This automated ROI graphic image is applied automatically in response to selection of the discrete region by the user, and the corresponding operating parameters are automatically generated based upon the location selected by the user at step 712, so as to determine whether a feature of interest is in the automated ROI graphic image. The feature of interest, as described in greater detail herein, can be a pattern (for which the operating parameters comprise X direction, Y direction and angle θ), a blob or sub-object (for which the operating parameters comprise X and Y directions) and an edge (for which the operating parameters are X direction and angle θ). The operating parameters determine the pass/fail region for the ROI graphic image such that a runtime image yields a pass result when the operating parameters are within the particular thresholds that are automatically assigned, and yields a fail result when the operating parameters are not within the particular thresholds (i.e. the feature of interest is not located within the ROI graphic image.

In accordance with the illustrative embodiment, repositioning of the graphic image by the user automatically resets the corresponding operating parameters. At step 714, the procedure continues by allowing the user to move the automated ROI graphic image from a first positioning to a second positioning. The user movement of the automated ROI graphic image can comprise resizing the automated ROI graphic image from a first size (positioning) to a second size, or moving the ROI graphic image from one position to another on the image. Repositioning of the ROI graphic image advances the procedure to step 716, in which the operating parameters are automatically reset to a predetermined value in accordance with the second positioning, as described in greater detail hereinbelow.

### Automated Pattern Position Tools

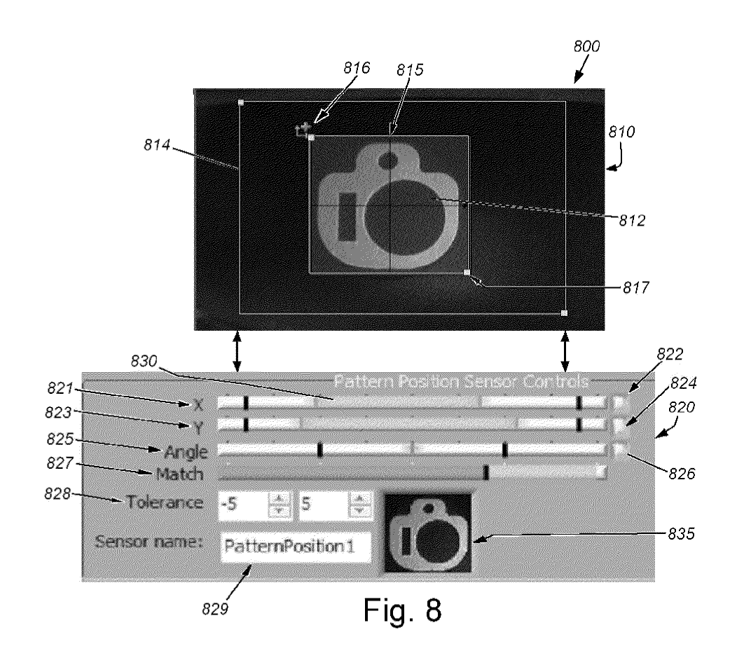

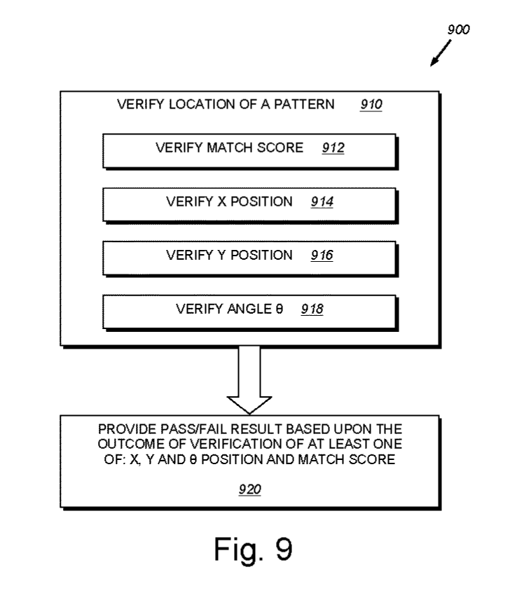

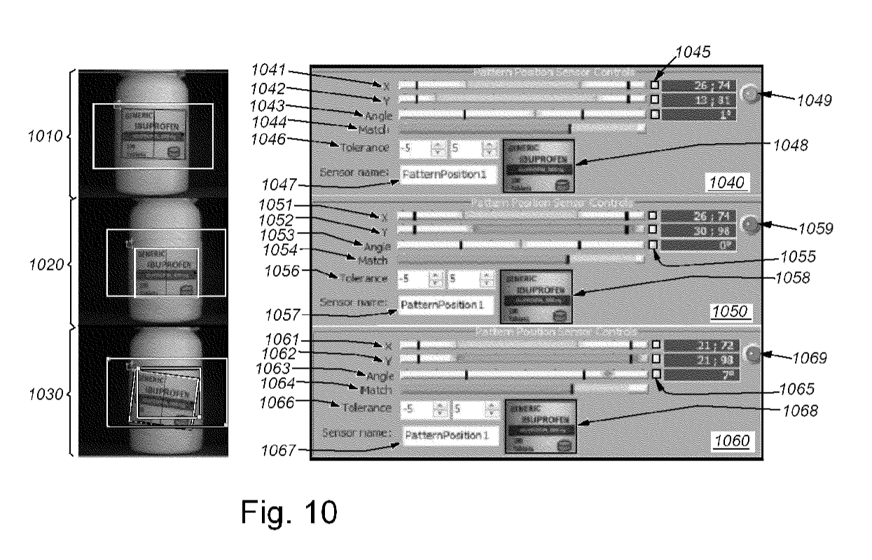

Reference is now made to FIGS. 8-10 relating to the generation and display of an automated region of interest (ROI) graphic image and corresponding automated operating parameters in accordance with the illustrative embodiments. FIG. 8 is a diagram of an exemplary GUI display showing a pattern position tool and the associated automated operating parameters, according to an illustrative embodiment. The associated procedure is shown in FIG. 9, and a corresponding application, with three illustrative operational examples, is shown in FIG. 10.

With reference to FIG. 8, a diagram of the exemplary GUI display 800 is shown, employing a pattern position tool in accordance with the illustrative embodiment. An image view display 810 illustrates the pattern 812 that is used in training an image. The pass/fail region 814 is applied to the image as the limits within which the automated ROI graphic image is applied. The automated ROI graphic image 815 is applied to the image based upon a single click by the user proximate the pattern 812 on the discrete region of the image view display 810. The automated ROI graphic image 815 is user-movable in size, for example by changing the position of either locator 816 or 817, which correspondingly changes the size of the ROI graphic image. Alternatively, the entire ROI graphic image 815 can be selected by the user and dragged, or otherwise moved, to the desired location. Note that the automated operating parameters for the particular pattern position tool are displayed in the control box 820. The operating parameters include: X direction 821 (which can be disabled during runtime operation by user selection of box 822), Y direction 823 (which can be disabled during runtime operation by user selection of box 824), angle 825 (which can be disabled during runtime operation by user selection of box 826) and match score 827. The match score 827 is an operating parameter that is adjustable via a slider, while the X position, Y position and angle parameters can either be turned on or off. In accordance with the illustrative embodiment, the operating parameters 821, 823, 825 and 827 are generated automatically in response to selection, and/or positioning, of the automated ROI graphic image. A user can also select a tolerance 828, for example −5 to +5, for runtime operation of the operating parameters. A name can also be applied to the particular pattern position tool in the text entry box 829. Note that the position of the object 830 is shown in the control box as highlighted on the bar for the X position operating parameter 821. Also, the training pattern image 835 is shown to be compared to the runtime operation image.

Referring to FIG. 9, a procedure 900 is shown for generating, displaying and applying a pattern position tool, according to the illustrative embodiment. As shown, the procedure commences at step 910 by verifying the location of a pattern. The match score is verified at 912, and it the match score does not pass, then a fail result is yielded automatically, without testing the other operating parameters. According to an illustrative embodiment, once the match score is verified, the procedure can verify the X position at 914, verify the Y position at 916 and/or verify the angle θ 918. The various operating parameters are verified to determine whether a feature of interest is located within the ROI graphic image. At step 920, a pass or fail result is illustratively provided based upon the verification of at least one of an X, Y and θ position and the match score. As shown in FIG. 8, the user can select to ignore, or disable, a particular position measurement during calculations and runtime operation. Accordingly, only the position scores that have been selected are used in determining whether an object passes or fails for a particular runtime image. In accordance with the illustrative embodiment, the match score is determined first, and objects not passing the match score are not verified further. However, it is contemplated that the match score can be calculated at any time during the analysis, before or after other operating parameters, as will be apparent within ordinary skill.

Reference is now made to FIG. 10 showing a diagram of an exemplary GUI display for an exemplary runtime application of the pattern position tool, according to the illustrative embodiments, showing the system as it behaves after a single click by the user to apply a pattern position tool, without any further user intervention. As shown in FIG. 10, a pattern position tool is applied after the single click by the user for use in runtime operation and analysis of exemplary images 1010, 1020 and 1030. The corresponding position sensor controls, for each image 1010, 1020 and 1030, respectively, are shown in control box 1040, 1050 and 1060. The X position operating parameter 1041, Y position operating parameter 1042, angle position operating parameter 1043 and match score operating parameter 1044 are shown, with their values being automatically generated and displayed in response to the automated ROI graphic image. Each of the X, Y and angle position operating parameters 1041, 1042 and 1043, respectively, can be disabled by selection of the appropriate corresponding box 1045. The tolerance 1046 is also applied, and a sensor name can be given to the appropriate pattern position tool in text entry box 1047. The training image 1048 is shown in the control box 1040. Note that the particular runtime image 1010 is indicated in the control box 1040 by having a lighter “pass” color applied thereto at the pass/fail indicator 1049. This indicates that the label in the image 1010 is in the pass region, without requiring extensive input and manipulation by the user.

Runtime image 1020 presents another label for analysis in accordance with the illustrative embodiment. As shown, the X position operating parameter 1051, Y position operating parameter 1052, angle position operating parameter 1053 and match score operating parameter 1054 are shown, with their values being automatically generated and displayed in response to the automated ROI graphic image. Each of the X, Y and angle position operating parameters 1051, 1052 and 1053, respectively, can be disabled by selection of the appropriate corresponding box 1055. The tolerance 1056 is also shown, and a sensor name given to the appropriate pattern position tool is shown in text entry box 1057. The training image 1058 is shown in the control box 1050. Note that the particular runtime image 1020 is indicated in the control box 1050 as having a darker “fail” color applied thereto at the pass/fail indicator 1059. As shown, the Y position operating parameter 1052 is not within the pass region, and thus the particular label does not pass for this reason.

The runtime image 1030 presents another image containing a label for analysis in accordance with the illustrative embodiment. As shown, the X position operating parameter 1061, Y position operating parameter 1062, angle position operating parameter 1063 and match score operating parameter 1064 are shown, with their values being automatically generated and displayed in response to the automated ROI graphic image. Each of the X, Y and angle position operating parameters 1061, 1062 and 1063, respectively, can be disabled by selection of the appropriate corresponding box 1065. The tolerance 1066 is also shown, and a sensor name given to the appropriate pattern position tool is shown in text entry box 1067. The training image 1068 is shown in the control box 1060. Note that the particular runtime image 1030 is indicated in the control box 1060 as having a darker “fail” color applied thereto at the pass/fail indicator 1069. As shown, the Y position operating parameter 1062 is not within the pass region, and the angle position operating parameter 1063 is not within the pass region, and thus the particular label does not pass for these reasons. Accordingly, a user can graphically view the pass/fail region and associated operating parameters to determine whether an object yields a pass or fail results for inspection purposes.

### Automated Blob Position Tools

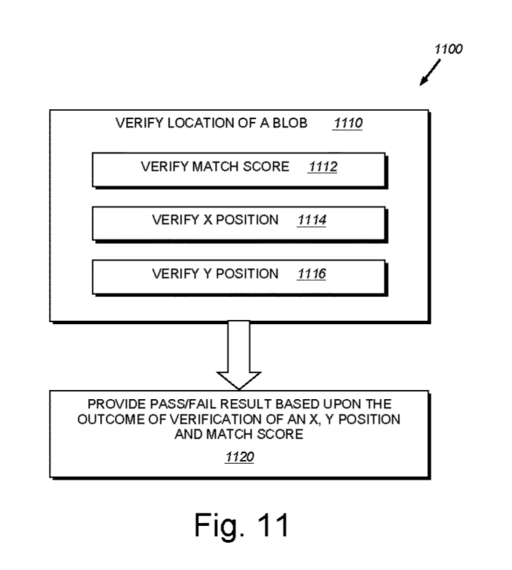

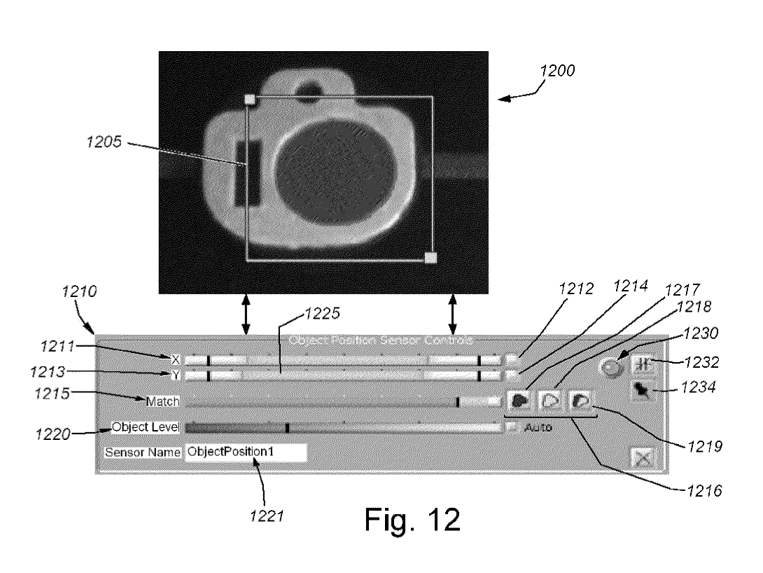

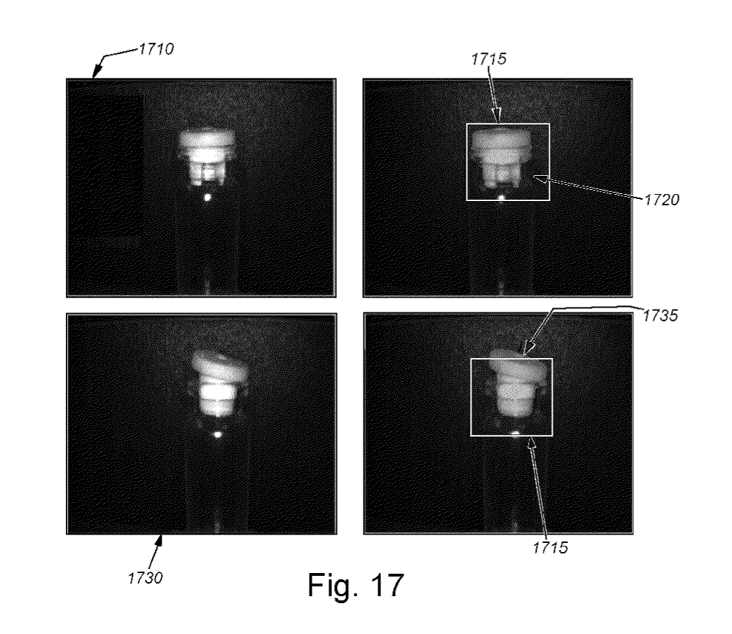

Reference is now made to FIGS. 11-17 relating to the generation, display and application of an automated region of interest (ROI) graphic image and corresponding automated operating parameters in accordance with the illustrative embodiments for a “blob” (sub-object or other portion of the overall object) position tool. FIG. 11 shows a flow chart of a procedure for generating a blob position tool, according to the illustrative embodiment. FIGS. 12-16 show diagrams of exemplary GUI displays for the blob position tool and various automated operating parameters, according to the illustrative embodiment. FIG. 17 is a perspective view of an exemplary operational application of the sub-object or blob position tool.

With reference to FIG. 11, a procedure 1100 is shown for generating, displaying and applying a blob (object or sub-object) position tool, according to the illustrative embodiments. As shown, the procedure commences at step 1110 by verifying the location of a blob. The match score 1112 is verified, and if this fails the procedure returns a fail result, in accordance with the illustrative embodiments. If the match score 1112 is verified, the procedure continues to verify the remaining operating parameters. The procedure then verifies the X position 1114 and/or the Y position 1116. The operating parameters are verified at step 1110, to determine whether a feature of interest is located within the ROI graphic image. The feature of interest, according to the blob position tool, comprises any sub-object or blob that is trained by the system during a training procedure. Once a particular position has been verified, at step 1120 the procedure illustratively provides a pass or fail result based upon the outcome of the verification of at least one of an X or Y position and the match score. As described herein, a user can select to ignore (or disable) a particular operating parameter during runtime operation by selecting an appropriate check box on the GUI. For example, if the X position is ignored, only the Y position and the match score are used in determining the pass or fail result. Likewise, if the Y position is ignored or disabled, only the X position and the match score are used in determining the pass or fail result.

Reference is now made to FIG. 12, showing the application of an operational exemplary blob position tool. A training image 1200 is shown having a pass/fail region 1205 is applied thereto. The corresponding object position sensor controls are displayed in a separate control box 1210. The control box 1210 shows the X position operating parameter 1211, with associated ignore box 1212, the Y position operating parameter 1213 and its associated ignore box 1214. The match score operating parameter 1215 is also shown. The polarity for the object is also assigned at 1216, so as to detect for dark objects 1217, light objects 1218, or for either light or dark objects 1219. The object level operating parameter 1220 is also shown. A sensor name for the object position sensor is shown in the text entry box 1221. Notably, the position of the object 1225 is shown on the scale of the operating parameters, for example the Y position of the object 1225 is depicted on the scale for the Y position operating parameter 1213. The pass/fail indicator 1230 indicated whether the exemplary operational image is within the pass region or not. The lighter color indicated by the indicator 1230 indicates that the exemplary operational image yields a pass result. The object position sensor control box 1210 can also include an invert output button 1232 which allows a user to enable to disable individual coordinates from the overall pass/fail result, as is readily apparent to those having ordinary skill in the art. The control box 1210 can also include a pin feature button 1234 which allows a user to “unpin” a particular feature (unselect the particular location of a feature) during analysis. A feature is typically pinned to the training image as a baseline image. However, this can be “unpinned” by selecting the pin feature button 1234.

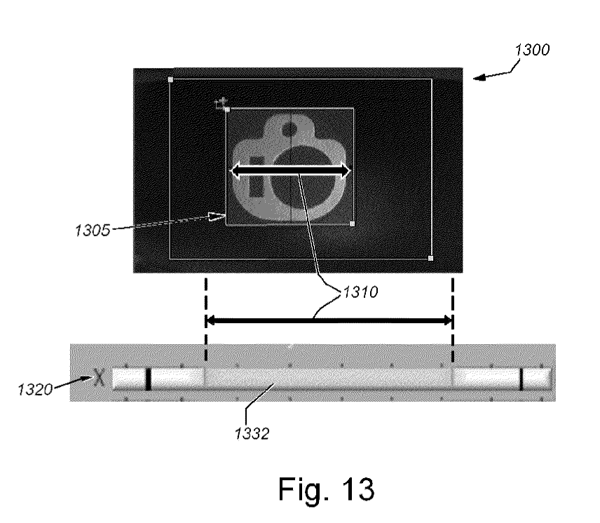

Reference is now made to FIG. 13 showing an X position operating parameter for an exemplary operational image, according to an illustrative embodiment. As shown in FIG. 13, the exemplary operational image 1300 is shown, and a ROI graphic image 1305 is applied to the operational image 1300. The width of the object 1310 is automatically determined and the associated X position operating parameter 1320 is automatically generated. The position of the object 1322 is shown on the scale threshold bar of the X position operating parameter 1320.

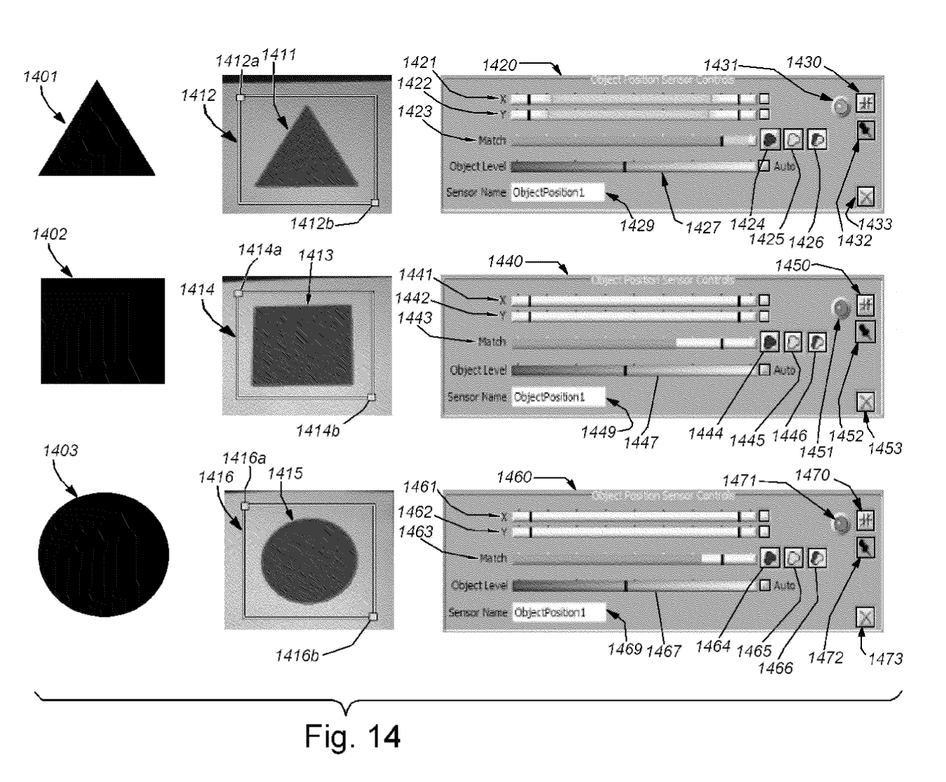

Reference is now made to FIG. 14 showing a diagram of an exemplary GUI display for the blob position tool application, detailing a match score operating parameter for exemplary operational images, according to the illustrative embodiment. As shown in FIG. 14, a trained object 1401, 1403 and 1405 is used for comparison to an exemplary operational object 1411, 1413 and 1415, respectively, to determine how well the runtime object (1411, 1413, 1415) matches the original trained object (1401, 1403, 1405) in both area and aspect ratio. A ROI graphic image 1412 is applied to the image of the exemplary runtime object 1411 to determine the match score. The match score uses the aspect ratio and area of an object to determine if the runtime object matches the trained object. For example, if a square, a long thin rectangle, or a circle are analyzed runtime (instead of a triangle as shown), the square, rectangle and circle may all have the same area, but only the circle and square have the same aspect ratio. The ROI graphic image 1412 includes boxes 1412a, 1412b to modify the positioning of the ROI graphic image as desired. A ROI graphic image 1414 is applied to the image of the exemplary runtime object 1413 to determine the match score. The ROI graphic image 1414 includes boxes 1414a, 1414b, used to modify the positioning of the ROI graphic image as desired by the user. Likewise, a ROI graphic image 1416 is applied to the image of the exemplary runtime object 1415 to determine the match score. The ROI graphic image 1416 includes boxes 1416a, 1416b, used to modify the positioning of the ROI graphic image as desired by the user.

The corresponding operating parameters for the exemplary runtime object 1411 are shown in control box 1420, and likewise the operating parameters for object 1413 are shown in control box 1440, and the operating parameters for object 1415 are shown in control box 1460. The X position operating parameters 1421, 1441 and 1461 are automatically generated and correspond to the X positions of the ROI graphic image 1412, 1414, and 1416, respectively. Similarly, the Y position operating parameters 1422, 1442 and 1462 are automatically generated and correspond to the Y positions of the ROI graphic image 1412, 1414 and 1416, respectively. The match operating parameters 1423, 1443 and 1463 are automatically generated and compare how well the exemplary operational object (1411, 1413, 1415) matches the original trained object (1401, 1403, 1405) in both area and aspect ratio. The object has a sufficient match score in each of the exemplary operational objects. The polarity is also automatically generated as being dark (1424, 1444, 1464), light (1425, 1445, 1465) or either light or dark (1426, 1446, 1466). The object level operating parameters (1427, 1447 and 1467) are also automatically generated and displayed in their respective control boxes 1420, 1440 and 1460. A sensor name is shown in the text entry box 1429, 1449, 1469.

The object position sensor controls for the operational exemplary object 1411 reveal that the pass/fail indicator 1431 indicates a pass result. This means that each of the operating parameters are within the threshold and thus yields a pass result. However, the position sensor controls for object 1413 show that the pass/fail indicator 1451 indicates a fail result. This indicates that at least one of the operating parameters has indicated that it is not within the pass region. The object position sensor controls shown for the operational exemplary object 1414 show that the pass/fail indicator 1471 indicates a fail result. Accordingly, at least one of the operating parameters has indicated that it is not within the pass region, and thus the object fails. As described hereinabove, the results can be inverted by selecting the invert button 1430, 1450, 1470, to invert the output results. As described herein, a pin feature button 1432, 1452, 1472 can be provided to unpin a particular feature of interest.

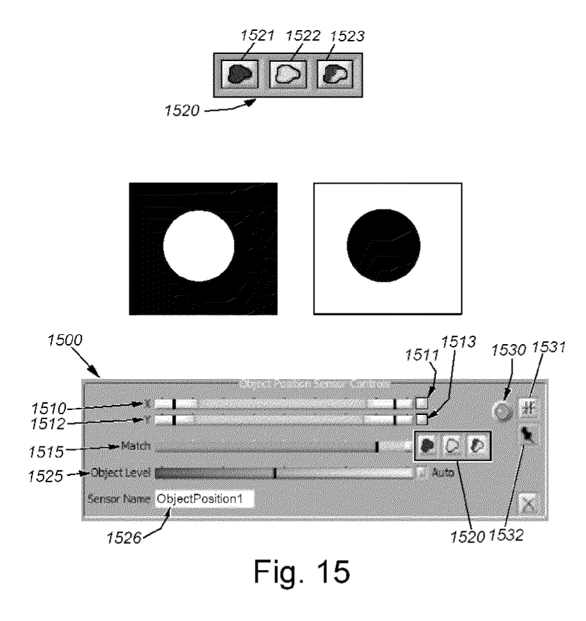

Reference is now made to FIG. 15 showing a diagram of an exemplary GUI display for the sub-object or blob position tool application, detailing an object polarity operating parameter, according to the illustrative embodiment. As shown, an object position sensor control box 1500 indicates the various operating parameters and threshold values associated therewith. The X position operating parameter 1510, with associated disable button 1511, and Y position operating parameter 1512, with associated disable button 1513, are shown, and correspond to the X and Y position thresholds for a particular position tool. The match score operating parameter 1515 matches the polarity 1520, as well as the object level 1525. The polarity 1520 is automatically set, based upon the ROI graphic image selected by the user, to detect for dark object by selecting button 1521, light objects by selecting button 1522, or both light and dark objects by selecting button 1523. The match score is assigned to a particular operational image based upon the match in both level of the object and polarity thereof. The sensor name applied to a particular position tool is shown in the text entry box 1526. As shown, the pass/fail indicator 1530 indicates a pass result for the particular object being analyzed. The results can be inverted using the invert feature button 1531, and also the pin feature button 1532 is provided.

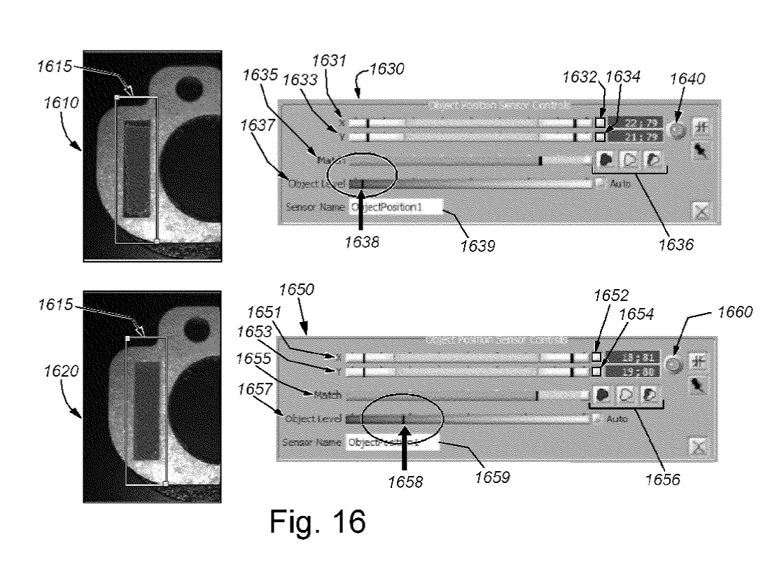

With reference to FIG. 16, a diagram of an exemplary GUI display is shown for the blob position tool application, detailing the operating parameter for object level, according to the illustrative embodiment. Exemplary operational images 1610 and 1620 are shown, each having an automated ROI graphic image 1615 applied thereto to determine whether a feature of interest is located within the ROI graphic image 1615. The corresponding position sensor control box 1630 is shown for the exemplary operational image 1610, and the control box 1650 is shown for the exemplary operational image 1620. In accordance with the illustrative embodiments, the X position operating parameters 1631, 1632 are generated, with the threshold values corresponding to the X position values for the ROI graphic image 1615. Likewise, the Y position operating parameters are generated, with the threshold values corresponding to the Y position values for the ROI graphic image 1615. The X position and Y position for both operational images 1610 and 1620 are shown within the pass region. The match score 1635 and 1655, respectively, for the image 1610 and 1620, illustrate that the object has a passing match score, and the polarity 1636, 1656 and object level 1637, 1657, are shown within the pass region. Note that although the object level 1637 for the operational image 1610 is at a different location 1638 along the slider than the location 1658 of the object level 1657 for the operational image 1620, however they both yield a pass result as indicated by the pass/fail indicators, respectively, 1640 and 1660. A name for the position sensor can also be applied or shown in text entry box 1639, 1659.

Reference is now made to FIG. 17 showing two illustrative examples of operational images in accordance with the illustrative embodiments. An exemplary operational image 1710 is acquired, and a ROI graphic image 1715 is applied to the image to determine whether a feature of interest (1720 in this example) is located within the ROI graphic image 1715 (the pass/fail region). The feature of interest 1720 is located within the ROI graphic image 1715 for the exemplary image 1710, and thus yields a pass result. However, when the ROI graphic image 1715 is applied to the exemplary operational image 1730, it is noted that the feature of interest 1735 is not located within the ROI graphic image, and thus yields a fail result. This provides users with a graphical vehicle for determining whether a feature of interest is at the desired location.

### Automated Edge Position Tools

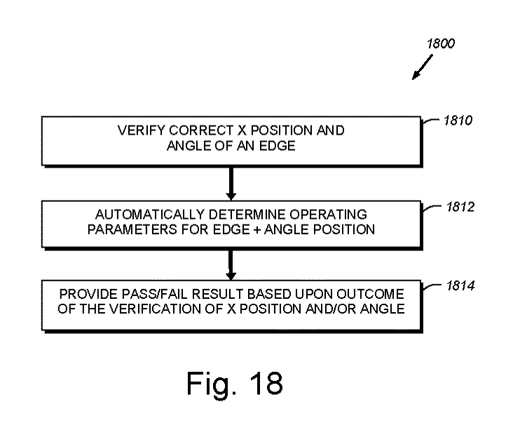

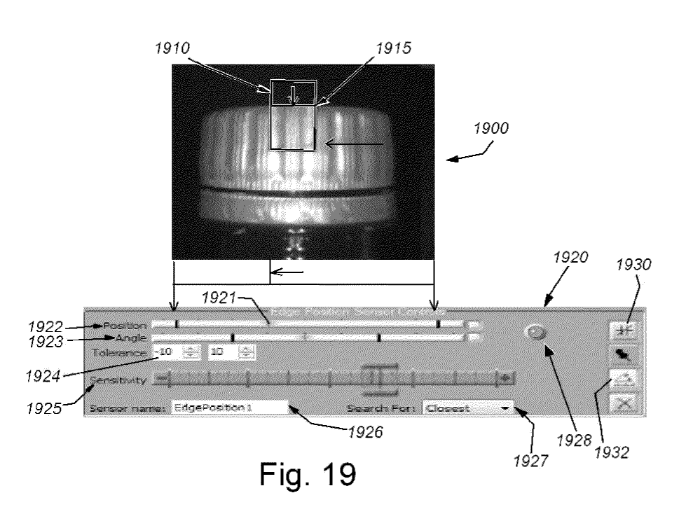

Reference is now made to FIGS. 18-19 relating to the generation, display and application of an automated ROI graphic image and corresponding automated operating parameters in accordance with the illustrative embodiments for an edge position tool. FIG. 18 shows a flow chart of a procedure for generating an edge position tool, according to the illustrative embodiment. FIG. 19 shows a diagram of an exemplary GUI display for the edge position tool and associated operating parameters, according to the illustrative embodiment.

Referring to FIG. 18, a procedure 1800 is shown for generating, displaying and applying an edge position tool, in accordance with the illustrative embodiment. As shown, the procedure commences at step 1810 by verifying the correct X position and angle of an edge. At step 1810, the angle tolerance can be enabled or disabled as appropriate to provide the desired threshold. At step 1812, operating parameters are automatically determined for the edge and angle position to determine whether the feature of interest (i.e. edge) is located within the ROI graphic image. At step 1814, a pass/fail result is provided based upon the outcome of the verification of X position and/or angle position of the feature of interest with respect to the ROI graphic image.

Reference is now made to FIG. 19 showing a diagram of an exemplary GUI display for the edge position tool and associated operating parameters, in accordance with the illustrative embodiment. An exemplary operational image 1900 is shown, having a ROI graphic image 1910 applied thereto. An edge position tool is applied to determine whether a feature of interest (edge) 1915 is located within the ROI graphic image 1910. The edge position sensor controls corresponding to the ROI graphic image 1910 are shown in the control box 1920. The position of the edge 1921, which corresponds to the position of the edge in the ROI graphic image 1910, is shown on the position operating parameter threshold bar 1922. The angle operating parameter 1923 is also shown. An angle tolerance 1924 (of ±20 degrees illustratively) is shown. The sensitivity 1925 of the edge detection can be set accordingly, A sensor name is provided in the text entry field 1926. The edge position sensor can search for various types of edges through use of a drop-down box 1927, which allows users to determine whether the sensor searches for the closest, first, last or strongest edges. The pass/fail indicator 1928 indicates whether a particular edge is within the pass region of the ROI graphic image. The output can be inverted using the invert output button 1930, to achieve the desired pass/fail region for the particular edge position sensor. The angle measurement can be disabled by selecting the angle measurement button 1932, which additionally allows the system to operate more quickly, without (free of) having to account for angle tolerance. These and other operating parameters are applicable and variable within ordinary skill.

It should now be clear that the above-described systems, methods, GUIs and automated position tools affords all users a highly effective vehicle for setting parameters to determine whether a feature of interest is at the correct position, such as a cap or label position, component placement, fill level, web or cable position, or other applications known in the art. The illustrative above-described systems, methods, and GUIs, are applicable to those of skill to determine whether a feature of interest (such as a pattern, blob or edge) is at the correct position, through use of a region of interest graphic image and associated operating parameters that are automatically generated.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the various illustrative embodiments have been shown and described primarily with respect to pattern, blob (object or sub-object) and edge position tools. However, any feature of interest can be searched for and analyzed in accordance with the illustrative embodiments shown and described herein to provide the appropriate pass/fail graphical region of interest to a user. Additionally, while a moving line with objects that pass under a stationary inspection station is shown, it is expressly contemplated that the station can move over an object or surface or that both the station and objects can be in motion. Thus, taken broadly the objects and the inspection station are in “relative” motion with respect to each other. Also, while the above-described “interface” (also termed a “vision system interface”) is shown as a single application consisting of a plurality of interface screen displays for configuration of both trigger logic and main inspection processes, it is expressly contemplated that the trigger logic or other vision system functions can be configured using a separate application and/or a single or set of interface screens that are accessed and manipulated by a user separately from the inspection interface. The term “interface” should be taken broadly to include a plurality of separate applications or interface screen sets. In addition, while the vision system typically performs trigger logic with respect to objects in relative motion with respect to the field of view, the objects can be substantially stationary with respect to the field of view (for example, stopping in the filed of view). Likewise, the term “screen” as used herein can refer to the image presented to a user which allows one or more functions to be performed and/or information related to the vision system and objects to be displayed. For example a screen can be a GUI window, a drop-down box, a control panel and the like. It should also be clear that the various interface functions and vision system operations described herein controlled by these functions can be programmed using conventional programming techniques known to those of ordinary skill to achieve the above-described, novel trigger mode and functions provided thereby. In general, the various novel software functions and operations described herein can be implemented using programming techniques and environments known to those of skill. Likewise, the depicted novel GUI displays, while highly variable in presentation and appearance in alternate embodiments, can also be implemented using tools and environments known to those of skill. Accordingly, this description is meant to be taken only by way of example, and not to otherwise limit the scope of this invention.

What is claimed is:

1. A graphical user interface (GUI) display for displaying and controlling vision system operating parameters, the GUI comprising:
an automated region of interest graphic image applied to a discrete region of a selected image in response to a single click by a user at the discrete region of the selected image, the selected image selected by the user from a window on the GUI display containing a plurality of captured images of an object; and
at least one automated operating parameter that is generated automatically in response to the single click by the user at the discrete region of the selected image to determine whether a feature of interest is in the automated region of interest graphic image;
wherein the automated region of interest graphic image is user-movable to allow the user to move the automated region of interest graphic image from a first positioning on the selected image to a second positioning on the selected image, to thereby automatically reset the at least one automated operating parameter to a predetermined value in accordance with the second positioning of the automated region of interest graphic image.

2. The GUI as set forth in claim 1 wherein the captured images vary from each other as a result of relative motion between the object and a field of view.

3. The GUI as set forth in claim 1 wherein the automated region of interest graphic image is applied by a pattern position tool and the feature of interest comprises a pattern.

4. The GUI as set forth in claim 3 wherein the at least one automated operating parameter comprises at least one of: an X position, a Y position and an angle position.

5. The GUI as set forth in claim 1 wherein the automated region of interest graphic image is applied by a blob position tool and the feature of interest comprises a blob.

6. The GUI as set forth in claim 5 wherein the at least one automated operating parameter comprises at least one of: an X position and a Y position.

7. The GUI as set forth in claim 1 wherein the automated region of interest graphic image is applied by an edge position tool and the feature of interest comprises an edge.

8. The GUI as set forth in claim 7 wherein the at least one automated operating parameter comprises at least one of: an X position and an angle position.

9. The GUI as set forth in claim 1 further comprising an indicator that yields a pass result when the feature of interest is located in the automated region of interest graphic image and a fail result when the feature of interest is not located in the automated region of interest graphic image.

10. The GUI as set forth in claim 1 wherein the at least one automated operating parameter is in a non-numeric graphical format and located in a separate control box displayed in the GUI.

11. A method for displaying and controlling vision system operating parameters comprising the steps of:
applying an automated region of interest graphic image to a discrete region of a selected image on a graphical user interface (GUI) in response to a single click by a user at the discrete region of the selected image, the selected image selected by the user from a window on the GUI containing a plurality of captured images of an object; and
generating at least one automated operating parameter automatically in response to the single click by the user at the discrete region of the selected image to determine whether a feature of interest is in the automated region of interest graphic image;
wherein the automated region of interest graphic image is user-movable to allow ii the user to move the automated region of interest graphic image from a first positioning on the selected image to a second positioning on the selected image, to thereby automatically reset the at least one automated operating parameter to a predetermined value in accordance with the second positioning of the automated region of interest graphic image.

12. The method as set forth in claim 11 wherein the captured images vary from each other as a result of relative motion between the object and a field of view.

13. The method as set forth in claim 11 further comprising the step of displaying the at least one automated operating parameter is a separate control box on the GUI, the at least one automated operating parameter being in a non-numeric graphical format.

14. The method as set forth in claim 11 further comprising the step of determining whether a feature of interest is located in the region of interest graphic image, the feature of interest comprising at least one of: an edge, a pattern and a blob.

15. The method as set forth in claim 11 further comprising the step of generating and displaying a second automated operating parameter automatically in response to the single click by the user at the discrete region of the selected image.

16. The method as set forth in claim 11 further comprising the step of disabling the at least one operating parameter during analysis of the selected image.

17. The method as set forth in claim 16 wherein the at least one operating parameter is disabled by a user selecting an appropriate check box on the GUI.

18. The method as set forth in claim 11 further comprising the step of yielding a pass result when the feature of interest is located in the automated region of interest graphic image or a fail result when the feature of interest is not located in the automated region of interest graphic image.

19. The method as set forth in claim 11 wherein the at least one operating parameter comprises edge polarity and the feature of interest comprises an edge, such that the edge polarity is automatically generated in response to the single click by the user at the discrete region of the selected image.

20. The method as set forth in claim 11 wherein the at least one operating parameter comprises object polarity that is automatically generated in response to the single click by the user at the discrete region of the selected image.

21. A system for displaying and controlling vision system operating parameters, the system comprising:
means for applying an automated region of interest graphic image to a discrete region of a selected image on a graphical user interface (GUI) in response to a single click by a user at the discrete region of the selected image, the selected image selected by the user from a window on the GUI containing a plurality of captured images of an object; and
means for generating at least one automated operating parameter automatically in response to the single click by the user at the discrete region of the selected image to determine whether a feature of interest is in the automated region of interest graphic image;
wherein the automated region of interest graphic image is user-movable to allow the user to move the automated region of interest graphic image from a first positioning on the selected image to a second positioning on the selected image, to thereby automatically reset the at least one automated operating parameter to a predetermined value in accordance with the second positioning of the automated region of interest graphic image.

22. The system as set forth in claim 21 further comprising means for yielding a pass result when the feature of interest is located in the automated region of interest graphic image and means for yielding a fail result when the feature of interest is not located in the automated region of interest graphic image
